(19) United States
(12) Patent Application Publication
(10) Pub. No.: US 2025/0071289 A1
(43) Pub. Date: Feb. 27, 2025

(54) ENCODER AND DECODER FOR IMPROVING THE QUALITY OF MONOCHROME ENHANCEMENT LAYER CODECS

(71) Applicant: MEDIATEK INC., Hsin-Chu (TW)

(72) Inventors: Shou-Ming Chen, Hsinchu City (TW); Yu-Cheng Chu, Hsinchu City (TW); Chia-Ying Li, Hsinchu City (TW)

(73) Assignee: MEDIATEK INC., Hsin-Chu (TW)

(21) Appl. No.: 18/811,785

(22) Filed: Aug. 22, 2024

Related U.S. Application Data
(60) Provisional application No. 63/520,942, filed on Aug. 22, 2023.

(51) Int. Cl. H04N 19/136; G06T 5/92; H04N 9/64; H04N 19/186; H04N 19/70

(52) U.S. Cl. CPC H04N 19/136; G06T 5/92; H04N 9/64; H04N 19/186; H04N 19/70; G06T 2207/10024; G06T 2207/20208

(57) ABSTRACT

An image encoder includes a tone mapper, an enhancement layer and an image file generator. The tone mapper is used to generate a base image according to an enhanced image and red green blue (RGB) gains. The RGB gains are set close to or the same as each other. The enhancement layer is used to generate a tone curve and/or a gain map of the base image and the enhanced image according to the tone mapper and/or a group including the base image and the enhanced image. The image file generator is used to generate an image file according to the base image and at least one member of a group including the tone curve and the gain map.

### CROSS REFERENCE TO RELATED APPLICATIONS

This application claims the benefit of U.S. Provisional Application No. 63/520,942, filed on Aug. 22, 2023. The content of the application is incorporated herein by reference.

### BACKGROUND

The term Codec combines compressor and decompressor. A codec is a device or program that compresses data so that it can be transmitted more quickly and decompressed by the receiving device. The purpose of codec is to speed up the storage and transmission of digital media because the original format of digital content usually requires a large amount of storage space.

Video codecs are hardware or software that compresses and decompresses digital video, reducing files to facilitate video storage and transmission. Codecs simultaneously optimize files for playback on a variety of devices. Video codecs play an important role when encoding videos. Video codecs simultaneously perform operations on video files and make copies of them, compressing the video for easy storage and transmission, and decompressing it for later viewing. There are basically two types of video-side decoders: lossless and lossy. Lossless codecs retain the original captured data after decompression, while lossy codecs create a “high-quality compressed version” of the original data by removing unnecessary data.

Codecs that use a base layer and enhancement layer to compress an enhanced image typically rely on a monochrome enhancement layer for computational and space efficiency. The monochrome enhancement layer belongs to lossy codecs. However, there is a visible color difference between the original enhanced image and the reconstructed enhanced image by using the monochrome enhancement layer. Therefore, an improved image encoder using the monochrome enhancement layer is desired.

### SUMMARY

An embodiment provides an image encoder including a tone mapper, an enhancement layer and an image file generator. The tone mapper is configured to generate a base image according to an enhanced image and red green blue (RGB) gains wherein the RGB gains are set close to or the same as each other. The enhancement layer is configured to generate a tone curve and/or a gain map of the base image and the enhanced image according to the tone mapper and/or a group comprising the base image and the enhanced image. The image file generator is configured to generate an image file according to the base image and at least one member of a group comprising the tone curve and the gain map.

Another embodiment provides a method for an image encoder including performing tone mapping to generate a base image according to an enhanced image and red green blue (RGB) gains wherein the RGB gains are set close to or the same as each other, generating an enhancement layer to generate a tone curve and/or a gain map of the base image and the enhanced image according to the tone mapping and/or a group comprising the base image and the enhanced image, generating an image file according to the base image and at least one member of a group comprising the tone curve and the gain map.

Another embodiment provides an image decoder including a file parser and a tone mapper. The file parser is configured to parse an image file to generate a base image and a tone curve. The tone mapper is configured to generate an enhanced image according to the tone curve and the base image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an image encoder according to an embodiment of the present invention.

FIG. 2 is a block diagram of the tone mapper according to an embodiment of the present invention.

FIG. 3 is a block diagram of an image decoder according to an embodiment of the present invention.

### DETAILED DESCRIPTION

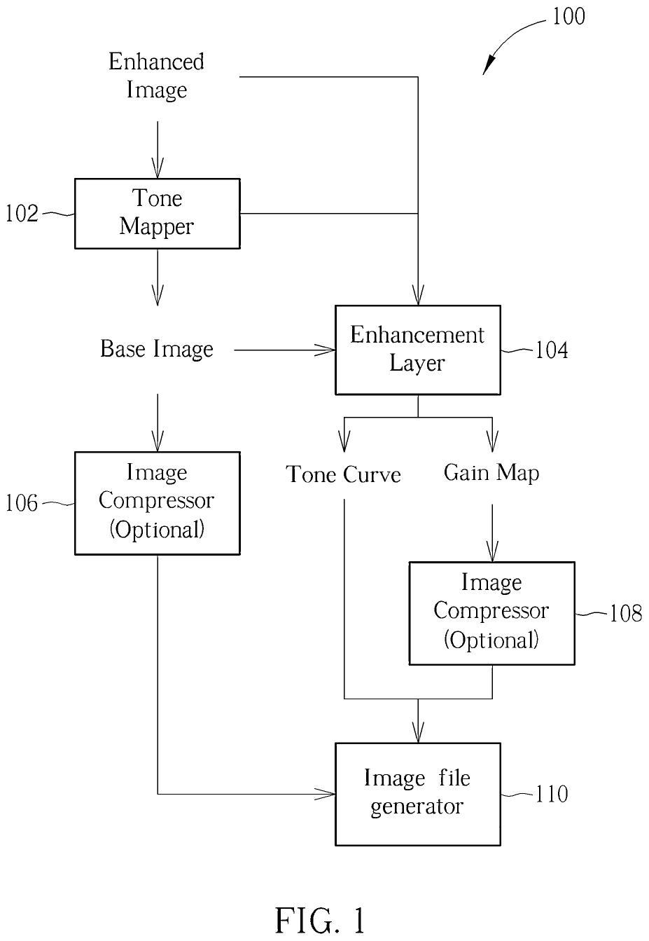

FIG. 1 is a block diagram of an image encoder 100 according to an embodiment of the present invention. The image encoder 100 includes a tone mapper 102, an enhancement layer 104 (for example, a module to process data for enhancement layer) and an image file generator 110. The tone mapper 102 is configured to generate a base image according to an enhanced image using tone mapping algorithm. In this invention, the red green blue (RGB) gains are set the same to each other. Therefore, the base image generated by tone mapping can be directly converted from the enhanced image by three simple equations:

$${R}^{′} = R \times f ( R , G , B )$$

$${G}^{′} = G \times f ( R , G , B )$$

$${B}^{′} = B \times f ( R , G , B )$$

where f (R,G,B) is the RGB gain. By using these equations in the image encoder 100, the codecs that use a monochrome enhancement layer for computational and space efficiency can still retain the image quality because the decoder can recover the enhanced image using only the luminance (i.e.f (R,G,B)) of the image. In another embodiment, the RGB gains are set close to each other but not the same. In some other embodiments, the RGB gains are set the same as each other. In this case, the decoder can still recover the enhanced image with little loss. In some other embodiment, gains for more than two color components can be set close to or the same as each other for applying the features of this invention, which should not be limited in this disclosure.

The enhancement layer 104 is configured to generate a tone curve and/or a gain map of the base image and the enhanced image according to the tone mapper 102 and/or a group comprising the base image and the enhanced image. In an embodiment, the tone curve carried by the enhancement layer 104 and the base image generated by the tone mapper 102 are inputted into the image file generator 110 to generate the image file. In another embodiment, the gain map carried by the enhancement layer 104 and the base image generated by the tone mapper 102 are inputted into the image file generator 110 to generate the image file. In some embodiments, a syntax may be written into the image file to determine whether a decoder needs to use the tone curve and/or the gain map. In some other embodiments, a syntax may be written in the image file to indicate if there is the tone curve and/or the gain map to be used for encoding or decoding. The image file generator 110 is configured to generate an image file according to the base image and at least one member of a group comprising the tone curve and the gain map. The tone curve represents the information of the RGB gain equation and consumes only small storage spaces. The gain map represents the RGB gain of every pixel in the image, thus takes a large amount of storage space.

In an embodiment, the image encoder 100 further includes a first image compressor 106 and a second image compressor 108. The first image compressor 106 is configured to compress the base image to generate a compressed base image, and the second image compressor 108 is configured to compress the gain map to generate a compressed gain map. If the first image compressor 106 and the second image compressor 108 are applied, then the image file generator 110 generates the image file according to the compressed base image and/or a group comprising the tone curve and the compressed gain map. If the first image compressor 106 is applied without the second image compressor 108, then the image file generator 110 generates the image file according to the compressed base image and/or a group comprising the tone curve and the gain map. If the second image compressor 108 is applied without the first image compressor 106, then the image file generator 110 generates the image file according to the base image and/or a group comprising the tone curve and the compressed gain map. In an embodiment, the base image is the standard dynamic range (SDR) image, and the enhanced image is the high dynamic range (HDR) image. In another embodiment, the base image can be the high dynamic range (HDR) image, and the enhanced image can be the standard dynamic range (SDR) image. In some other embodiments, the base image or the enhanced image can be generated using SDR, HDR or any other color processing technology, which should not be limited in this disclosure.

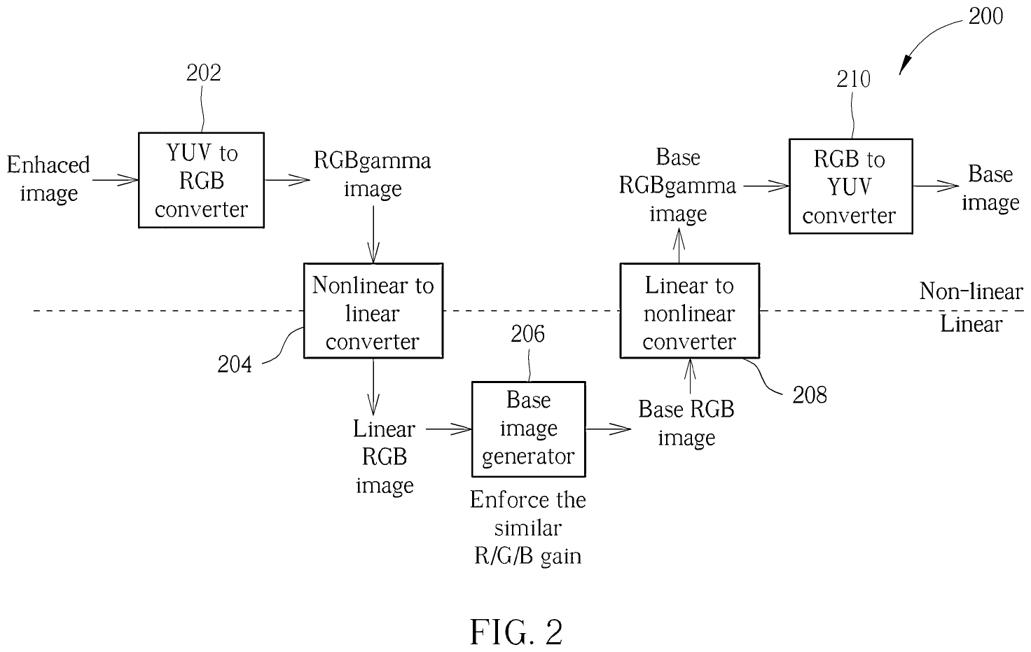

FIG. 2 is a block diagram of the tone mapper 200 according to an embodiment of the present invention. The tone mapper 200 includes a YUV to RGB converter 202, a nonlinear to linear converter 204, a base image generator 206, a linear to nonlinear converter 208, and an RGB to YUV converter 210. The YUV to RGB converter 202 generates an RGB gamma image according to the enhanced image. The nonlinear to linear converter 204 generates a linear RGB image according to the RGB gamma image. In an embodiment, the nonlinear to linear converter 204 can be performed based on a hybrid log-gamma (HLG) inverse opto-electronic transfer function (OETF). The base image generator 206 enforces the same RGB gain and applies it to generate a base RGB image according to the linear RGB image. In an embodiment, the base image generator 206 enforces similar RGB gains and applies them to generate a base RGB image according to the linear RGB image. The linear to nonlinear converter 208 generates a base RGB gamma image according to the base RGB image. In an embodiment, the linear to nonlinear converter 208 can be performed based on a standard red green blue (SRGB) opto-electronic transfer function (OETF). The RGB to YUV converter 210 generates the base image according to the base RGB gamma image. In an embodiment, the base image can be the SDR image, and the enhanced image can be the HDR image. By using the tone mapper 200, the codec using the monochrome layer can reconstruct the enhanced image less lossy to maintain the image quality.

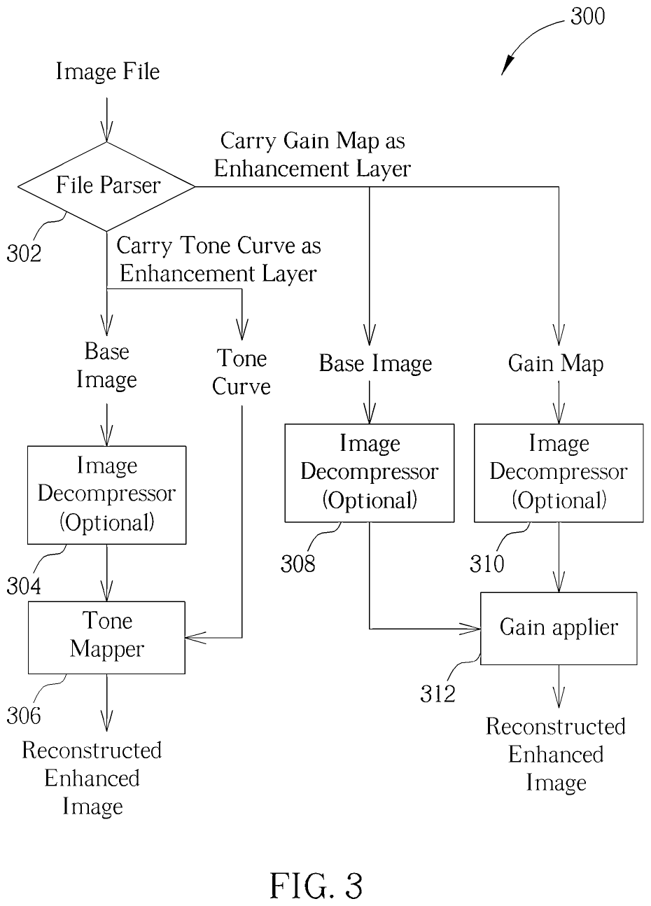

FIG. 3 is a block diagram of an image decoder 300 according to an embodiment of the present invention. The image decoder 300 includes a file parser 302, a tone mapper 306, a gain applier 312. The file parser 302 parses the image file to decide whether to decode the image by using the tone curve and the base image, or to decode the image by using the gain map and the base image. If the file parser 302 decides to decode the image file by using the tone curve and the base image, then the file parser 302 would parse the image file to generate the base image and the tone curve, and the base image and the tone curve are inputted into the tone mapper 306 to generate a reconstructed enhanced image. The tone mapping can be performed using the RGB gain equation carried by the tone curve and recover the reconstructed enhanced image.

If the file parser 302 decides to decode the image file by using the gain map and the base image, then the file parser 302 would parse the image file to generate the base image and the gain map, and the base image and the gain map are inputted into the gain applier 312 to generate a reconstructed enhanced image. The reconstructed enhanced image can be recovered by applying every RGB gain carried by the gain map to the base image.

In an embodiment, if the base image has been compressed in the encoder 100, and the file parser 302 decides to decode the image file by using the tone curve and the base image, then the base image is inputted to a first image decompressor 304 to generate a decompressed base image, and the decompressed base image and the tone curve are inputted into the tone mapper 306 to generate a reconstructed enhanced image.

In another embodiment, if the base image and the gain map have been compressed in the encoder 100, and the file parser 302 decides to decode the image file by using the gain map and the base image, then the base image is inputted to a second image decompressor 308 to generate a decompressed base image, the gain map is inputted to a third image decompressor 310 to generate a decompressed gain map, and the decompressed base image and the decompressed gain map are inputted into the gain applier 312 to generate a reconstructed enhanced image.

In an embodiment, the base image is the SDR image, and the reconstructed enhanced image is the HDR image. In another embodiment, the base image is the HDR image, and the reconstructed enhanced image is the SDR image.

In conclusion, the encoder and decoder according to an embodiment in the present invention can reconstruct the lossless enhanced image using monochrome layer codecs, thus improving the computational and space efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image encoder, comprising:
a tone mapper configured to generate a base image according to an enhanced image and red green blue (RGB) gains wherein the RGB gains are set close to or the same as each other;
an enhancement layer configured to generate a tone curve and/or a gain map of the base image and the enhanced image according to the tone mapper and/or a group comprising the base image and the enhanced image;
an image file generator configured to generate an image file according to the base image and at least one member of a group comprising the tone curve and the gain map.

2. The image encoder of claim 1 further comprising a first image compressor configured to generate a compressed base image according to the base image;
wherein the image file generator generates the image file according to the compressed base image and at least one member of a group comprising the tone curve and the gain map.

3. The image encoder of claim 1 further comprising a second image compressor configured to generate a compressed gain map according to the gain map generated by the enhancement layer;
wherein the image file generator generates the image file according to the base image and at least one member of a group comprising the tone curve and the compressed gain map.

4. The image encoder of claim 1 further comprising:
a first image compressor configured to generate a compressed base image according to the base image; and
a second image compressor configured to generate a compressed gain map according to the gain map;
wherein the image file generator generates the image file according to the compressed base image and at least one member of a group comprising the tone curve and the compressed gain map.

5. The image encoder of claim 1, wherein the tone mapper comprises:
a YUV to RGB converter configured to generate an RGB gamma image according to the enhanced image;
a nonlinear to linear converter linked to the YUV to RGB converter, and configured to generate a linear RGB image according to the RGB gamma image;
a base image generator linked to nonlinear to linear converter, and configured to convert the linear RGB image to a base RGB image using the RGB gains;
a linear to nonlinear converter linked to the base image generator, and configured to generate a base RGB gamma image according to the base RGB image; and
an RGB to YUV converter linked to the linear to nonlinear converter, and configured to generate the base image according to the base RGB gamma image.

6. The image encoder of claim 5, wherein the enhanced image is a high dynamic range (HDR) image or a standard dynamic range (SDR) image.

7. The image encoder of claim 5, wherein the base image is a standard dynamic range (SDR) image or a high dynamic range (HDR) image.

8. The image encoder of claim 5, wherein the nonlinear to linear converter is performed based on a hybrid log-gamma (HLG) inverse opto-electronic transfer function (OETF).

9. The image encoder of claim 5, wherein the linear to nonlinear converter is performed based on a standard red green blue (sRGB) opto-electronic transfer function (OETF).

10. A method for an image encoder, comprising:
performing tone mapping to generate a base image according to an enhanced image and red green blue (RGB) gains wherein the RGB gains are set close to or the same as each other;
generating an enhancement layer to generate a tone curve and/or a gain map of the base image and the enhanced image according to the tone mapping and/or a group comprising the base image and the enhanced image;
generating an image file according to the base image and at least one member of a group comprising the tone curve and the gain map.

11. The method of claim 10, further comprising compressing the base image to generate a compressed base image;
wherein generating the image file according to the base image and at least one member of a group comprising the tone curve and the gain map is generating the image file according to the compressed base image and at least one member of a group comprising the tone curve and the gain map.

12. The method of claim 10, further comprising compressing the gain map to generate a compressed gain map;
wherein generating the image file according to the base image and at least one member of a group comprising the tone curve and the gain map is generating the image file according to the base image and at least one member of a group comprising the tone curve and the compressed gain map.

13. The method of claim 10, further comprising:
compressing the base image to generate a compressed base image;
compressing the gain map to generate a compressed gain map;
wherein generating the image file according to the base image and at least one member of a group comprising the tone curve and the gain map is generating the image file according to the compressed base image and at least one member of a group comprising the tone curve and the compressed gain map.

14. The method of claim 10, wherein performing tone mapping to generate the based image according to the enhanced image and the RGB gains comprises:
performing a YUV to RGB conversion to generate an RGB gamma image according to the enhanced image;
performing a nonlinear to linear conversion to generate a linear RGB image according to the RGB gamma image;
generating a base RGB image using the RGB gains according to the linear RGB image;
performing a linear to nonlinear conversion to generate a base RGB gamma image according to the base RGB image; and
performing an RGB to YUV conversion to generate the base image according to the base RGB gamma image.

15. An image decoder, comprising:
a file parser configured to parse an image file to generate a base image and a tone curve; and
a tone mapper configured to generate an enhanced image according to the tone curve and the base image.

16. The image decoder of claim 15, further comprising:
a first image decompressor configured to decompress the base image to generate a decompressed base image;
wherein the tone mapper generates the enhanced image according to the tone curve and the decompressed base image.
